(19) United States
(12) Patent Application Publication
(10) Pub. No.: US 2015/0371247 A1
(43) Pub. Date: Dec. 24, 2015

(54) POINT OF SALE SURVEY ON PACKAGING FOR IMMEDIATE FEEDBACK

(71) Applicant: Empire Technology Development LLC, Wilmington, DE (US)

(72) Inventor: Ezekiel Kruglick, Poway, CA (US)

(21) Appl. No.: 14/763,161

(22) PCT Filed: Feb. 14, 2013
(86) PCT No.: PCT/US13/26072

§ 371 Date: Jul. 23, 2015

(51) Int. Cl. G06Q 30/02; G06Q 20/20

(52) U.S. Cl. CPC G06Q 30/0203; G06Q 20/20; G06Q 30/0238; G06Q 30/0217; G06Q 20/208

(57) ABSTRACT

Technologies are presented for POS surveying and incentivizing consumers through immediate feedback. A consumer may purchase a product with a label including a product identifier and a survey, which may include one or more response selection. The consumer may indicate a response to the survey by modifying a product identifier and/or exposing a supplemental identifier. The product identifier and survey response identifiers may be machine-readable identifiers such as a barcode or a QR code and scanned at POS. The product identification may be provided to a store's inventory system, and an incentive system may send instructions to the POS to provide the consumer with immediate incentive for their feedback. The survey response received by the incentive system may then be provided to a product manufacturer or brand manager's survey system.

### BACKGROUND

Unless otherwise indicated herein, the materials described in this section are not prior art to the claims in this application and are not admitted to be prior art by inclusion in this section.

Survey companies may spend considerable funds each year on consumer surveys in order to understand consumer choices and what reasons they may have to buy their products. Using survey-on-product methods, the companies may try to get consumers to respond through mail and/or website portals, but may have limited and/or delayed feedback along with higher costs to implement a custom infrastructure.

Mail or phone surveys do not always provide accurate results and can be costly too. Survey companies or manufacturers need to determine contact information for consumers or determine target groups through other means. Even then, successful response collection rates tend to be low because advertising-weary consumers may not always respond to incentives in the mail or hang up on survey callers.

### SUMMARY

The present disclosure generally describes techniques for Point of Sale (POS) surveying and incentivizing consumers through immediate feedback.

According to some examples, a method is provided for surveying consumers at a Point of Sale (POS) location. The method may include detecting a product identification and a survey response on a purchased item from two distinct identifiers or a single combination identifier at the POS location, where the survey response may be exposed through a consumer action on the purchased item. The method may also include providing the survey response to a survey system. The method may further include providing the consumers an incentive at the POS.

According to other examples, a Point of Sale (POS) system for surveying consumers is described for surveying and incentivizing consumers through immediate feedback. The system may include a scanning module configured to detect a product identification and a survey response on a purchased item from two distinct identifiers or a single combination identifier, where the survey response may be exposed through a consumer action on the purchased item. The system may also include a processing module configured to provide the survey response to a survey system and provide the consumers an incentive.

According to further examples, an item identification system with survey capability is described for POS surveying and incentivizing consumers through immediate feedback. The system may include a product identifier on an item. The system may also include two or more survey response selections on the item, configured to expose corresponding survey response identifiers machine-readable at a Point of Sale (POS) system when removed by a consumer action.

According to some embodiments, a computer-readable storage medium is described with instructions stored thereon for surveying consumers at a Point of Sale (POS) location, the instructions causing a method to be executed on a computing device. The executed method may include detecting a product identification and a survey response on a purchased item from two distinct identifiers or a single combination identifier at the POS location, where the survey response is exposed through a consumer action on the purchased item. The executed method may also include providing the survey response to a survey system. The executed method may further include providing the consumers an incentive at the POS.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system, where survey responses on item packaging may be scanned and immediate incentive provided to a consumer at Point of Sale (POS) locations;

FIGS. 2A and 2B illustrate an example of survey-directed product labeling, where removal of a label corresponding to a survey response exposes a machine-readable identifier associated with that survey response;

FIGS. 3A and 3B illustrate another example of survey-directed product labeling, where a combination identifier identifying the product may be modified by the consumer to expose a machine-readable survey response;

FIG. 4 illustrates example components and their actions in an example system for POS surveying and incentivizing consumers through immediate feedback;

FIG. 5 illustrates a general purpose computing device, which may be used for POS surveying and incentivizing consumers through immediate feedback;

FIG. 6 is a flow diagram illustrating an example method for POS surveying and incentivizing consumers through immediate feedback that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn to methods, apparatus, systems, devices, and/or computer program products related to surveying and incentivizing consumers through immediate feedback at a POS location.

Briefly stated, technologies are generally described for POS surveying and incentivizing consumers through immediate feedback. A consumer may purchase a product with a label including a product identifier and a survey, which may include one or more response selections. The consumer may indicate a response to the survey by modifying a product identifier and/or exposing a supplemental identifier. The product identifier and survey response identifiers may be machine-readable identifiers such as a barcode or a QR code and scanned at POS. The product identification may be provided to a store's inventory system, and an incentive system may send instructions to the POS to provide the consumer with immediate incentive for their feedback. The survey response received by the incentive system may then be provided to a product manufacturer or brand manager's survey system.

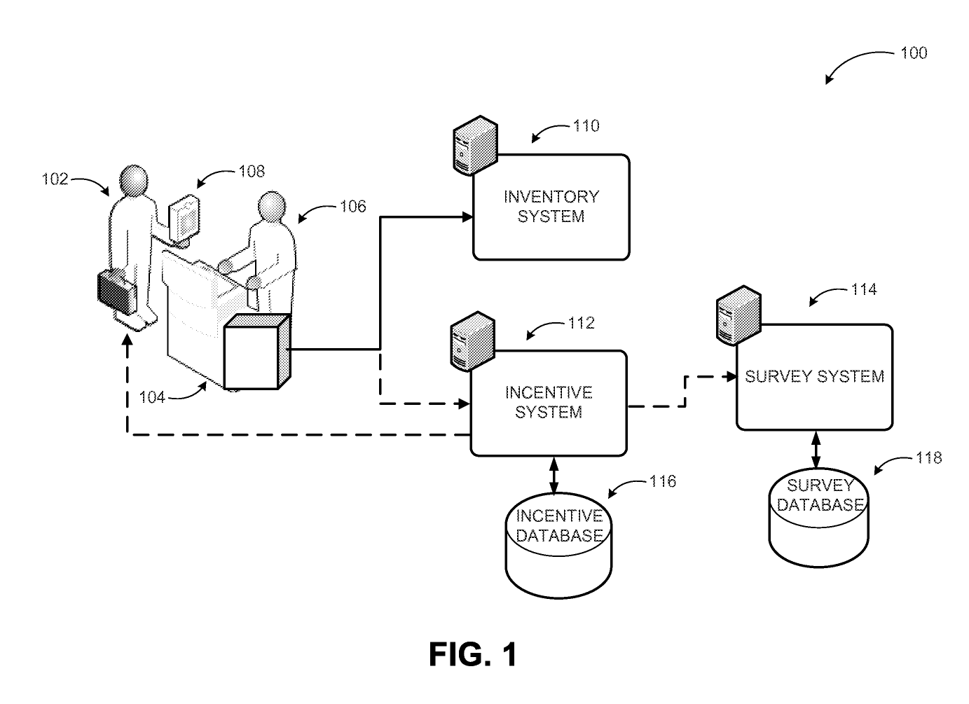

FIG. 1 illustrates an example system, where survey responses on item packaging may be scanned and immediate incentive provided to a consumer at Point of Sale (POS) locations, arranged in accordance with at least some embodiments described herein.

As shown in a diagram 100, a consumer 102 may approach a POS 104 and an employee 106 to purchase a product 108 that may include a label with a product identifier and a survey. To indicate his/her survey response, the consumer 102 may perform an action to modify the product identifier and/or expose a supplemental identifier, which the employee 106 may scan at the POS 104 to be detected. The POS 104 may then provide product identification to an inventory system 110, as well as provide survey response information to an incentive system 112 and a survey system 114. The incentive system may share the survey response information with an incentive database 116 and may deliver an immediate incentive to the consumer. The survey system 114 may store the survey response information within a survey database.

By introducing Point of Sale (POS) surveys, the companies may obtain valuable, immediate feedback. Surveying at a POS location may be advantageous because the consumers may already be handling a product at purchase time and may have the spare time to provide a response while waiting in line for checkout. With existing infrastructure, products may already be scanned for product information at checkout, so a survey response may also be scanned, reducing implementation costs. Furthermore, high-uptake may be achieved with the ability to offer immediate incentives to consumers for their feedback.

According to some examples, POS surveying may generate survey value by increasing the lifecycle value and rate of feedback. Prior to checkout, the consumer 102 may indicate a survey response by modifying a product identifier and/or exposing an associated supplemental identifier on a product label through peeling, scratching, and/or rendering a RFID-tag operational. The product identifier and the supplemental identifier may be a barcode, QR code, and/or information stored in a pre-programmed RFID tag. Upon scanning the one or more identifiers, a product identification and survey response may be detected on the purchased item from two distinct identifiers or a single combination identifier. The product identification may proceed to an inventory system 110 as usual. The modified and/or exposed identifiers may proceed to an incentive system 112 and a survey system 114, where they may register as a coupon to handle tracking, incentive discounts, and delivery of data to product manufacturers. Incentive information may be sent to an incentive database 116, delivering immediate incentive to the consumer in the form of an immediate discount, a printed coupon, and/or a future credit. In addition, a seller may possess previous data from consumer loyalty programs that may also be linked to the incentive system and may deliver that data to the survey system. Delivery of the incentive may then occur through contact information associated with the consumer through the loyalty program. Survey response information may be sent to a survey database 118 where the time, place, selected survey encodings, and possibly other purchase data may be used to compose a survey result.

POS surveying may also be beneficial because the information systems at POS locations may already process and pass along purchase data to product providers. Product identification and coupon management software may already be in use and the latter may already be capable of handling multiple coupons that apply to single products. These systems may also be used to provide a discount at the POS. As a result, the product identifier and supplemental identifier may be handled through existing infrastructure and consumers may receive immediate feedback. A new survey database may be installed at the manufacturer or brand manager, but no change or knowledge at the POS locations may be necessary, allowing for immediate implementation. This system may be also advantageous because the survey response may show up as a coupon on a register and/or receipt allowing the consumer to observe if the supplemental identifier was registered or not and point out if their discount may have been missed.

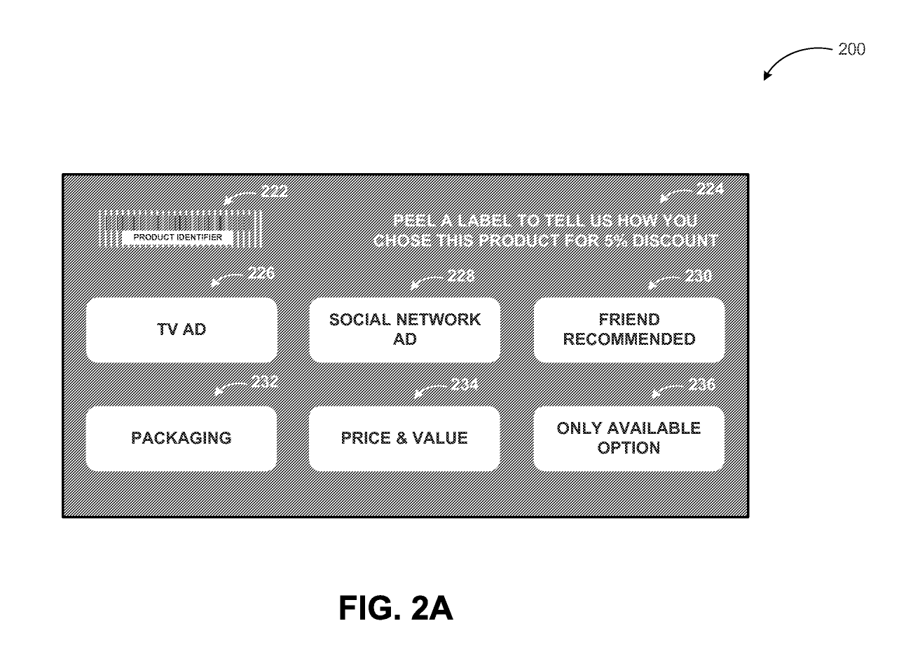

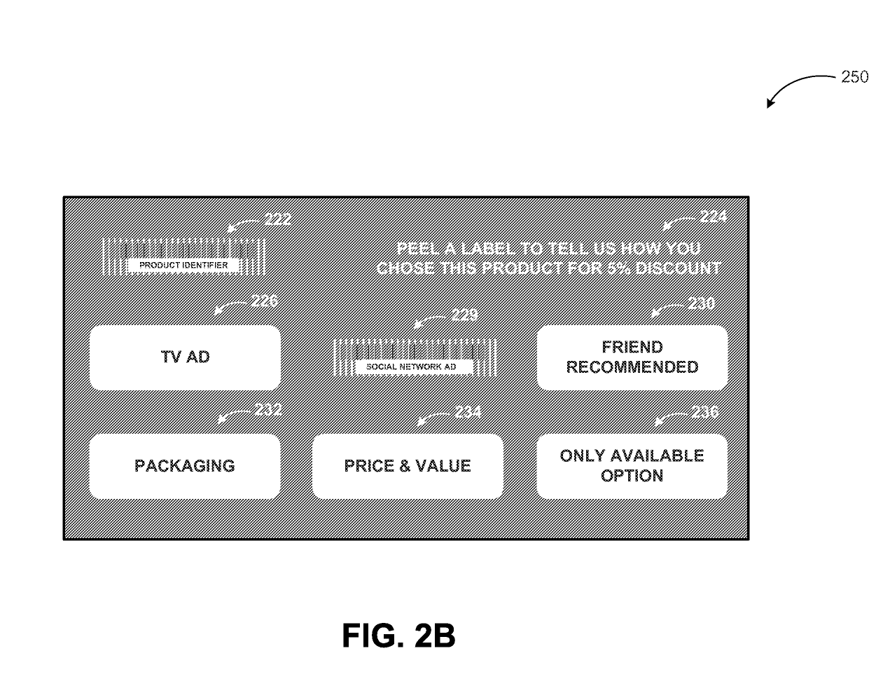

FIGS. 2A and 2B illustrate an example of survey-directed product labeling, where removal of a label corresponding to a survey response exposes a machine-readable identifier associated with that survey response, arranged in accordance with at least some embodiments described herein.

As shown in a diagram 200, a product may have a label that includes a product identifier 222 and text 224 that may inform the consumer how to indicate their survey input. One or more sub-labels 226, 228, 230, 232, 234, and 236 may be present on the label to represent survey response selections. In the illustrated example configuration, the text 224 instructs the consumer to “Peel a label” to provide information on why the consumer is choosing to purchase this product in order to receive a discount. Sub-label 226 corresponds to a survey response “TV Ad”, sub-label 228 corresponds to a survey response “Social Network Ad”, sub-label 230 corresponds to a survey response “Friend Recommended”, sub-label 232 corresponds to a survey response “Packaging”, sub-label 234 corresponds to a survey response “Price & Value”, and sub-label 236 corresponds to a survey response “Only Available Option”. Survey responses may be in any order and may be varied in order or placement, such as to remove survey biases due to response order.

As shown in a diagram 250, a sub-label corresponding to a survey response may be removed to expose a supplemental, machine-readable identifier 229, which may be associated with that particular survey response. In the illustrated example configuration, the sub-label corresponding to a survey response “Social Network Ad” was removed to expose the supplemental identifier 229.

According to some embodiments, survey formats may be established using two distinct identifiers, a primary product identifier and supplemental identifiers which may be exposed through consumer action. For example, a consumer may purchase a product that may have a label and/or box with a primary product identifier and one or more sub-labels that may allow a consumer to indicate their reason for purchase. Example response selections may include television ad, social network ad, price and value, etc. Each possible response selection may be a peel off sticker and/or packaging element with a supplemental identifier beneath. The consumer may peel away one of the stickers and/or packaging elements over the supplemental identifier to indicate that they were led to the product by a social network ad, such as a Facebook advertisement. The revealed supplemental identifier may act as a coupon, providing a discount to the consumer and delivering a particular coupon back to the product vendor indicating which survey choice the consumer made. Multiple stickers may be peeled, but more discounts may not be given as grocery systems may already allow coupon data formats to indicate combination rules.

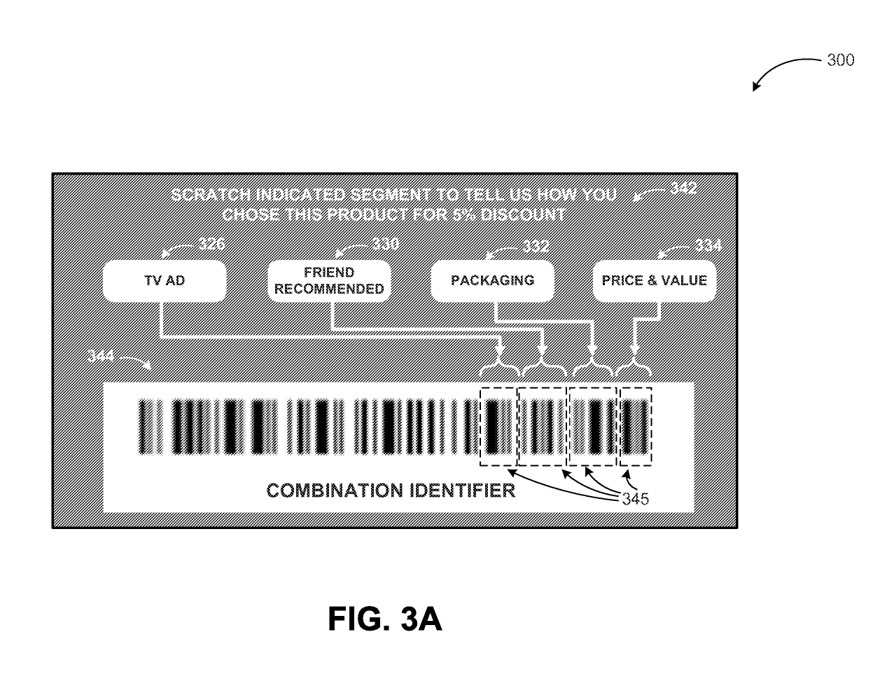

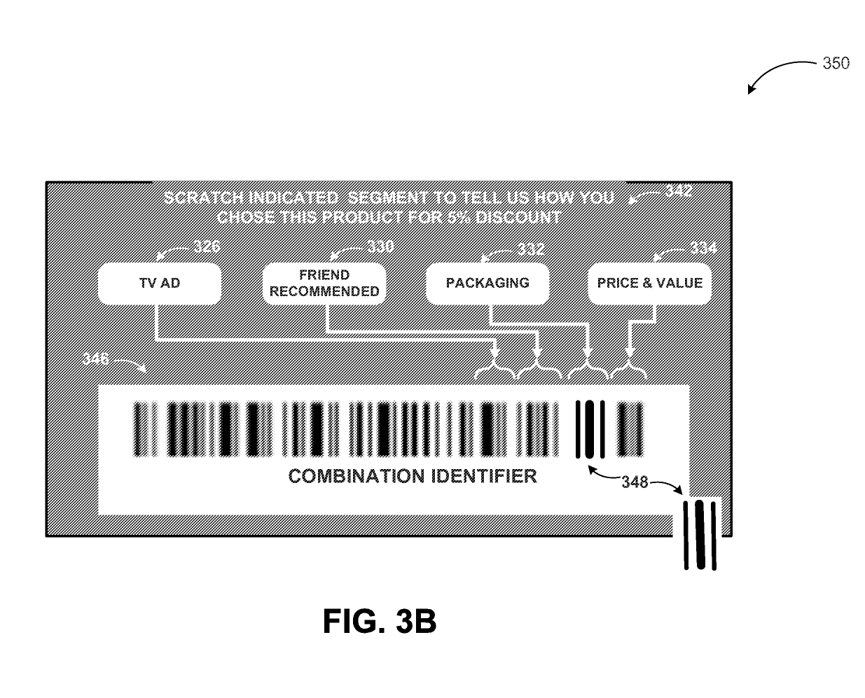

FIGS. 3A and 3B illustrate another example of survey-directed product labeling, where a combination identifier identifying the product may be modified by the consumer to expose a machine-readable survey response, arranged in accordance with at least some embodiments described herein.

As shown in a diagram 300, a product may have a label that includes multiple survey response selections 326, 330, 332, and 334. The label may also include text 342 that may inform the consumer how to indicate their survey input, and a combination identifier 344 that may include a product identifier. In the illustrated example configuration, the text 342 instructs the consumer to “scratch indicated segment” to provide information on why the consumer is choosing to purchase this product in order to receive a discount. In the illustrated example, survey response selection 326 corresponds to a “TV Ad”, survey response selection 330 corresponds to “Friend Recommended”, survey response selection 332 corresponds to a “Packaging”, and survey response selection 334 corresponds to “Price & Value”. Each of the survey response selections may be in form of peelable or scratchable barcode segments 345 that is part of the combination identifier. By peeling or scratching one of the barcode segments 345, the user may modify the combination identifier allowing the scanner to read the survey response along with the product identifier.

As shown in a diagram 350, the survey response selection 332 may be exposed by peeling of a label or removing an ink cover over a portion of a combination identifier 344 that includes the product identifier. The portion of the combination identifier 344 that may be modified by the consumer may expose a supplemental, barcode segment 348 (a machine-readable identifier), which may be associated with that particular survey response. In the illustrated example configuration, the segment indicating the survey response selection “Packaging” was scratched off to expose the supplemental identifier, barcode segment 348.

According to other embodiments, survey formats may also be established using a single combination identifier, which may be created through modification of a product identifier. For example, a rub or scratch-off ink cover may remove and/or reshape the contents of the product identifier, which may be a bar code and/or QR code. The ink cover may be chemical ink of any material, including metallic, and may be removed through peeling or scratching. For example, the identifier may have two thick lines indicating binary ones printed on scratch-off ink. Rubbing off the wax/ink layer may reveal two thinner lines indicating binary zeros. Different QR codes may also exist on top of and below the scratch-off ink.

Such survey formats may have the benefit of scanning and outputting a single identifier so that a response may not be missed. However, the inventory system may need to have multiple entries to reflect the different possible identifiers that the product may display and those entries need to reflect appropriate survey incentives. The inventory system may also need to reconcile the multiple possible product identifiers to a single inventory item line.

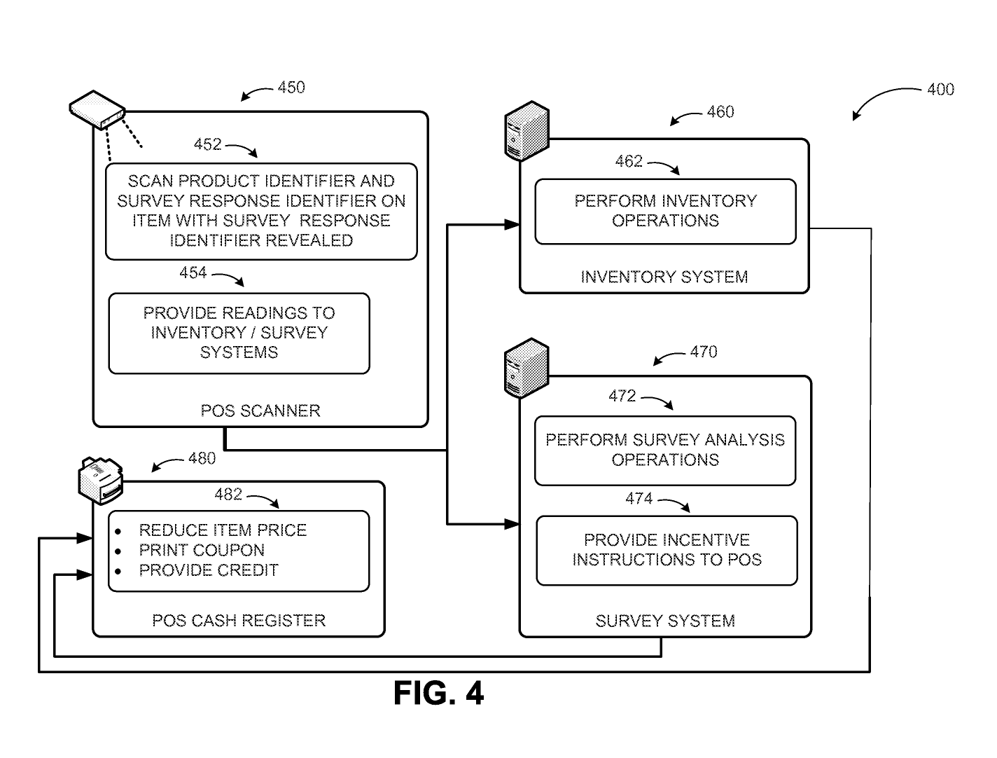

FIG. 4 illustrates example components and their actions in an example system for POS surveying and incentivizing consumers through immediate feedback, arranged in accordance with at least some embodiments described herein.

As shown in a diagram 400, a POS scanner 450 may scan a product identifier and a revealed survey response identifier on an item label 452 and may provide readings to inventory and/or survey systems 454. The inventory system 460 may perform inventory operations 462. The survey system 470 may perform survey analysis operations 472 and may provide incentive instructions to POS 474. Upon receiving the incentive instructions, a POS cash register 480 may reduce the item price, print a coupon, and/or provide credit 482.

Scanning at the POS may detect the product identification and survey response on the purchased item from two distinct identifiers or a single combination identifier. The product identification information may proceed to the store's inventory system. The modified and/or exposed identifier information may proceed to the product manufacturer or brand manager's survey system and database, where the time, place, selected survey encodings, and possibly other purchase data may be used to compose a survey result. Instructions regarding incentive information may be sent to the POS, delivering immediate incentive to the consumer according to their survey response. The incentive may be in the form of an automatic discount, a printed coupon, and/or a credit for future.

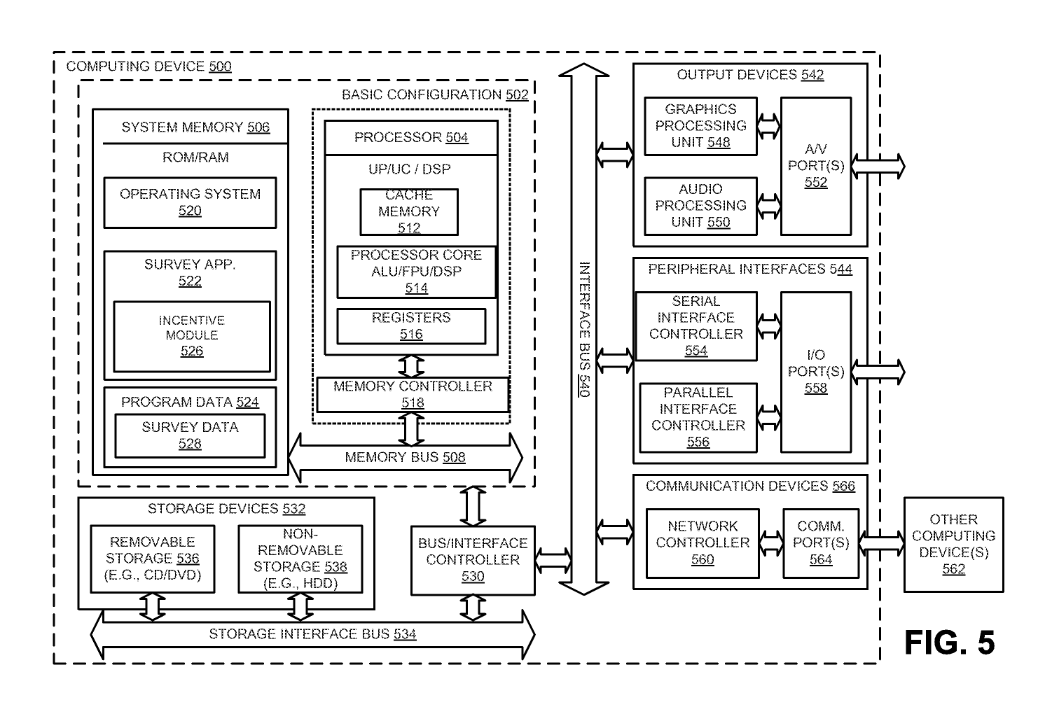

FIG. 5 illustrates a general purpose computing device, which may be used for POS surveying and incentivizing consumers through immediate feedback, arranged in accordance with at least some embodiments described herein.

For example, the computing device 500 may be used to provide a survey response to a survey system and to provide consumers with an immediate incentive as described herein. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (IP), a microcontroller (LIC), a digital signal processor (DSP), or any combination thereof. The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a survey application 522, and program data 524. The survey application 522 may include an incentive module 526 to provide immediate incentive to the consumer as described herein. The program data 524 may include, among other data, survey data 528 or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 544, and one or more communication devices 566) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 566 includes a network controller 560, which may be arranged to facilitate communications with one or more other computing devices 562 over a network communication link via one or more communication ports 564. The one or more other computing devices 562 may include servers at a manufacturer, survey entity, advertiser, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods for surveying and incentivizing consumers through immediate feedback at POS. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

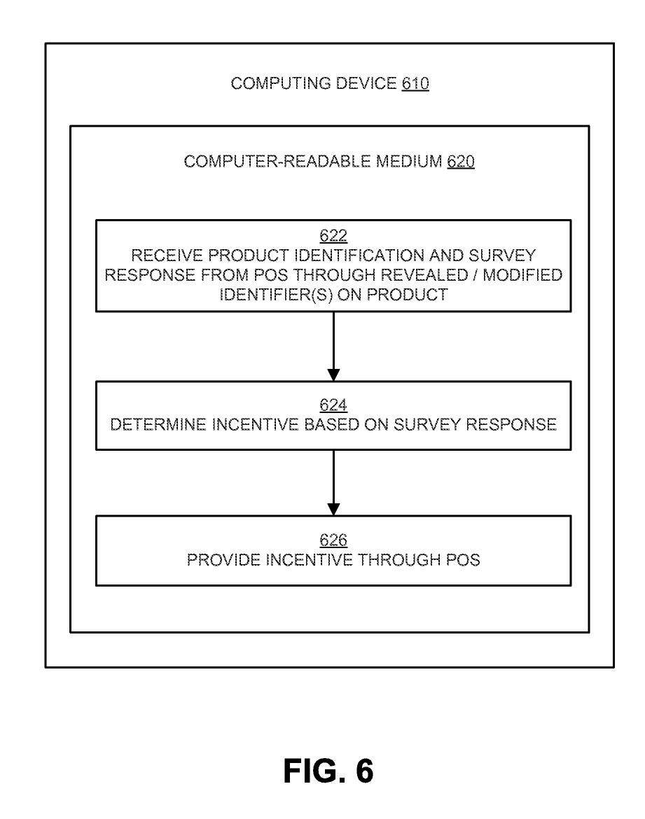

FIG. 6 is a flow diagram illustrating an example method for POS surveying and incentivizing consumers through immediate feedback that may be performed by a computing device such as the computing device in FIG. 5, arranged in accordance with at least some embodiments described herein.

Example methods may include one or more operations, functions or actions as illustrated by one or more of blocks 622, 624, and/or 626, and may in some embodiments be performed by a computing device such as the computing device 500 in FIG. 5. The operations described in the blocks 622-626 may also be stored as computer-executable instructions in a computer-readable medium such as a computer-readable medium 620 of a computing device 610.

An example process for POS surveying and incentivizing consumers through immediate feedback may begin with block 622, “RECEIVE PRODUCT IDENTIFICATION AND SURVEY RESPONSE FROM POS THROUGH REVEALED/MODIFIED IDENTIFIER(S) ON PRODUCT”, where a POS scanner 450 may detect a product and survey response identifier, from one or more identifiers, on a product 108 where the survey response identifier may have been modified and/or revealed. The POS scanner may then provide the product identification and survey response readings to an inventory system 460 and survey system 470, respectively.

Block 622 may be followed by block 624, “DETERMINE INCENTIVE BASED ON SURVEY RESPONSE”, where an incentive system 112 and incentive database 116 may define an incentive according to the survey response.

Block 624 may be followed by block 626, “PROVIDE INCENTIVE THROUGH POS”, where the incentive system 112 may provide instructions to the POS cash register 480 on how the defined incentive may be provided to the consumer 102.

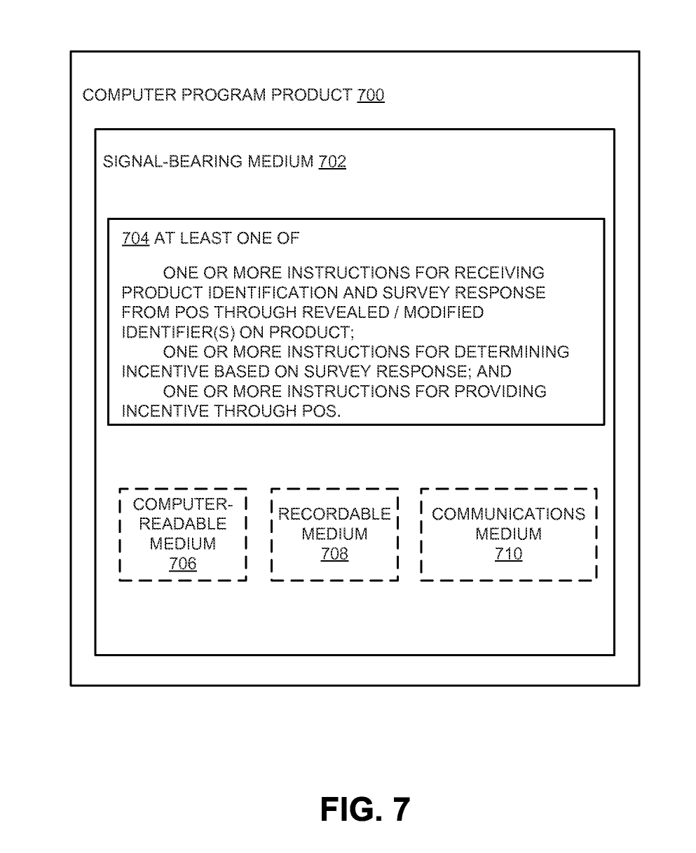

FIG. 7 illustrates a block diagram of an example computer program product, arranged in accordance with at least some embodiments described herein.

In some examples, as shown in FIG. 7, the computer program product 700 may include a signal bearing medium 702 that may also include one or more machine readable instructions 704 that, when executed by, for example, a processor, may provide the functionality described herein. Thus, for example, referring to the processor 504 in FIG. 5, the survey application 522 or the incentive module 526 may undertake one or more of the tasks shown in FIG. 7 in response to the instructions 704 conveyed to the processor 504 by the medium 702 to perform actions associated with providing survey response to a survey system and providing consumers with an immediate incentive as described herein. In some embodiments, the survey operations may take place at a different location, computing device while the POS system performs the incentive operations and forwards user responses to the remote survey system. Some of those instructions may include, for example, receiving a product identification and survey response from POS through revealed/modified identifier (s) on product, determining incentive based on survey response, and providing incentive through POS, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the program product 700 may be conveyed to one or more modules of the processor 704 by an RF signal bearing medium, where the signal bearing medium 702 is conveyed by the wireless communications medium 710 (e.g., a wireless communications medium conforming with the IEEE 802.11 standard).

According to some examples, a method is provided for surveying consumers at a Point of Sale (POS) location. The method may include detecting a product identification and a survey response on a purchased item from two distinct identifiers or a single combination identifier at the POS location, where the survey response is exposed through a consumer action on the purchased item. The method may also include providing the survey response to a survey system. The method may further include providing the consumers an incentive at the POS.

According to other examples, the incentive may be provided in form of an automatic discount, a printed coupon, or a credit for future purchases. The product identification may be provided to an inventory system. The consumers may expose the survey response by peeling of a label or removing an ink cover over a supplemental identifier corresponding to the survey response. Available survey response selections may be provided on multiple labels or ink covers over multiple supplemental identifiers on the purchased item, where the supplemental identifiers may include a barcode or a QR code.

According to further examples, the consumers may expose the survey response by peeling of a label or removing an ink cover over a portion of a combination identifier that includes the product identification, where the combination identifier may be configured to provide a combination of the product identification and the survey response in response to the peeling of the label or the removal of the ink cover and the combination identifier may include a barcode or a QR code. The consumers may expose multiple survey responses by offering groups of survey selections such that one response per group is valid but the incentive accrues across different groups. The consumers may also expose the survey response by rendering a pre-programmed RFID tag on the purchased item operational through the consumer action.

According to some embodiments, a Point of Sale (POS) system for surveying consumers is described for surveying and incentivizing consumers through immediate feedback. The system may include a scanning module configured to detect a product identification and a survey response on a purchased item from two distinct identifiers or a single combination identifier, where the survey response is exposed through a consumer action on the purchased item. The system may also include a processing module configured to provide the survey response to a survey system and provide the consumers an incentive.

According to other embodiments, the processing module may further be configured to provide the incentive in form of an automatic discount, a printed coupon, or a credit for future purchases. The processing module may also be configured to provide the product identification to an inventory system, where at least one of the survey system and the inventory system may be part of an item manufacturer. The survey response may be configured to be exposed by peeling of a label or removing an ink cover over a supplemental identifier corresponding to the survey response, where available survey response selections may be provided on multiple labels or ink covers over multiple supplemental identifiers on the purchased item and the supplemental identifiers may be a barcode or a QR code.

According to further embodiments, the survey response may be configured to be exposed by peeling of a label or removing an ink cover over a portion of a combination identifier that includes the product identification, where the combination identifier may be configured to provide a combination of the product identification and the survey response in response to the peeling of the label or the removal of the ink cover and the combination identifier may be a barcode or a QR code. Multiple survey responses may be configured to be exposed by offering groups of survey selections such that one response per group is valid but the incentive accrues across different groups. The survey response may also be configured to be exposed by rendering a pre-programmed RFID tag on the purchased item operational through the consumer action.

According to some examples, an item identification system with survey capability is described for POS surveying and incentivizing consumers through immediate feedback. The system may include a product identifier on an item. The system may also include two or more survey response selections on the item, configured to expose corresponding survey response identifiers machine-readable at a Point of Sale (POS) system when removed by a consumer action.

According to other examples, the survey response selections may be configured to be removed through one or more of peeling of a label, scratching of an ink cover, or rendering operational of a pre-programmed RFID tag, where the peeled label or the scratched ink cover may expose a barcode or a QR code. The product identifier and the survey response selections may be attached to the item as one or more labels or painted on the item and the product identifier and the survey response identifiers may include a barcode or a QR code. The survey response identifiers may be exposed through modification of at least a portion of a combination identifier that includes the product identifier, where the combination identifier may include a barcode or a QR code. An indication may be present on the item alerting a consumer about the availability of an incentive to the consumer for exposing a survey response identifier.

According to some embodiments, a computer-readable storage medium is described with instructions stored thereon for surveying consumers at a Point of Sale (POS) location, the instructions causing a method to be executed on a computing device. The executed method may include detecting a product identification and a survey response on a purchased item from two distinct identifiers or a single combination identifier at the POS location, where the survey response is exposed through a consumer action on the purchased item. The executed method may also include providing the survey response to a survey system. The executed method may further include providing the consumers an incentive at the POS.

According to other embodiments, the incentive may be provided in form of an automatic discount, a printed coupon, or a credit for future purchases. The product identification may be provided to an inventory system. The consumers may expose the survey response by peeling of a label or removing an ink cover over a supplemental identifier corresponding to the survey response. Available survey response selections may be provided on multiple labels or ink covers over multiple supplemental identifiers on the purchased item, where the supplemental identifiers may include a barcode or a QR code.

According to further embodiments, the consumers may expose the survey response by peeling of a label or removing an ink cover over a portion of a combination identifier that includes the product identification, where the combination identifier may be configured to provide a combination of the product identification and the survey response, in response to the peeling of the label or the removal of the ink cover. The combination identifier may include a barcode or a QR code. The consumers may expose multiple survey responses by offering groups of survey selections such that one response per group is valid but the incentive accrues across different groups. The consumers may also expose the survey response by rendering a pre-programmed RFID tag on the purchased item operational through the consumer action.

### EXAMPLES

Following are illustrative examples of how some embodiments may be implemented, and are not intended to limit the scope of embodiments in any way.

### Example 1

### A Homemaker Purchasing Laundry Detergent with a POS Peel-Off Survey Label

A homemaker may want to try a new brand of laundry detergent to wash her family's clothes. The homemaker's friend may have recommended a brand of detergent that optimally removes stains and odor and the homemaker may want to purchase the new brand of detergent at a supermarket. While headed to the checkout line at the supermarket, the homemaker may notice a product identifying barcode and a survey including multiple sub-labels on the side label of the laundry detergent. Text on the label may inform the homemaker to peel one of the sub-labels to indicate why the homemaker chose to purchase the laundry detergent in order to receive a “buy one get one free” coupon to be used on a future laundry detergent purchase. The sub-labels may correspond to the following survey responses: television ad, social network ad, friend recommended, price & value, and packaging. The homemaker may want to receive a coupon for future purchases and may peel the sub-label corresponding to the survey response friend recommended. Peeling the sub-label may reveal a supplemental barcode associated with the survey response friend recommended.

At the POS, a supermarket employee may scan the product identifying barcode and revealed supplemental barcode on the laundry detergent label. The POS scanner may detect a product identification and a survey response from the two distinct barcodes. The product identification may be sent to the supermarket's inventory system and the survey response information may be sent to an incentive system. The incentive system, upon receiving the survey response, may immediately send instructions to the POS cash register to print a “buy one get one free” coupon for a future laundry detergent purchase to be given to the homemaker. The incentive system may also provide the survey response information to a detergent manufacturing company's survey system. The survey system may analyze and store the survey response information to be used by the detergent manufacturing company. The company may use these results to improve manufacturing strategies in order to increase value of product and in turn increase sales.

### Example 2

### A Teenager Buying a Video Game with POS Scratch-Off Survey Packaging

A teenager may want to purchase a newly-released video game at a local gamer store after seeing a promotional television ad. Waiting in line to purchase the video game, the teenager may notice a scratch-off survey on the game's packaging. Text on the packaging may inform the teenager to scratch a segment of a combination barcode that corresponds to a reason why the teenager chose to purchase the video game in order to receive a 5% discount at the register. The scratch-off segments may correspond to the following survey responses: television ad, social network ad, magazine, friend recommended, price, and packaging. The teenager may want to receive a 5% discount at the register and may scratch off the segment corresponding to the response television ad, modifying the combination barcode.

At the POS, an employee of the gamer store may scan the modified combination barcode on the video game packaging. The POS scanner may detect a product identification and a survey response from the single combination barcode. The product identification may be sent to the gamer store's inventory system and the survey response information may be sent to a video game marketing company's survey system. The POS cash register may issue an immediate 5% discount on the video game being purchased by the teenager upon detecting the survey response in the combination barcode. The survey system may also analyze and store the survey response information to be used by the video game marketing company. The company may use these results to improve marketing strategies in order to increase sales.

### Example 3

### A Fisherman Purchasing a Tackle Box with a POS Peel-Off Survey Label

A fisherman may want to purchase a new tackle box for an upcoming fishing trip. His current tackle box may be poorly made and falling apart. He may have researched the internet to find a better quality tackle box at a good value and may have found a brand of tackle box he would like to purchase at a sporting goods store nearby. While headed to the checkout line at the sporting goods store, the fisherman may notice a product identifying barcode and a survey including multiple sub-labels on the side label of the tackle box. Text on the label may inform the fisherman to peel one of the sub-labels to indicate how he heard about the brand of tackle box in order to receive a coupon code allowing online registration into a contest to win a weekend fishing trip for four people. The sub-labels may correspond to the following survey responses: television, magazine, internet, and through a friend. The fisherman may want to be entered into the contest and may peel the sub-label corresponding to the survey response internet. Peeling the sub-label may reveal a supplemental QR code associated with the survey response internet.

At the POS, an employee of the sporting goods store may scan the product identifying barcode and the revealed supplemental QR code on the tackle box label. The POS scanner may detect a product identification and a survey response from the two distinct codes. The product identification may be sent to the sporting goods store's inventory system and the survey response information may be sent to an incentive system. The incentive system, upon receiving the survey response, may immediately send instructions to the POS cash register to print a coupon code that may allow the fisherman to register online for the contest to win a weekend fishing trip for four people. The incentive system may then provide survey response information to a brand manager's survey system. The survey system may analyze and store the survey response information to be used by the tackle boxes' brand manager. The company may use these results to adjust marketing strategies in order to increase brand sales.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to survey consumers at a point of sale (POS) location, the method comprising:
detecting a product identification and a survey response on a purchased item from two distinct identifiers or a single combination identifier by a POS scanner at the POS location, wherein the survey response is exposed through a consumer action on the purchased item;
providing the survey response to one or more servers of a survey system; and
providing the consumers an incentive at the POS.

2. The method of claim 1, further comprising:
providing the incentive in form of an automatic discount, a printed coupon, or a credit for future purchases.

3. The method of claim 1, further comprising:
providing the product identification to one or more servers of an inventory system.

4. The method of claim 1, further comprising:
allowing the consumers to expose the survey response by peeling of a label or removing an ink cover over as supplemental identifier corresponding to the survey response.

5. The method of claim 4, further comprising:
providing available survey response selections on a plurality of labels or ink covers over a plurality of supplemental identifiers on the purchased item, wherein the supplemental identifiers include a barcode or a QR code.

6. (canceled)

7. The method of claim 1, further comprising:
allowing the consumers to expose the survey response by peeling of a label or removing an ink cover over a portion of a combination identifier that includes the product identification.

8. The method of claim 7, wherein the combination identifier is configured to provide a combination of the product identification and the survey response in response to the peeling of the label or the removal of the ink cover.

9. The method of claim 7, wherein the combination identifier includes a barcode or a QR code.

10. The method of claim 1, further comprising:
allowing the consumers to expose multiple survey responses by offering groups of survey selections such that one response per group is valid but the incentive accrues across different groups.

11. The method of claim 1, further comprising:
allowing the consumers to expose the survey response by rendering a pre-programmed RFID tag on the purchased item operational through the consumer action.

12. A point of sale (POS) system to survey consumers, the POS system comprising:
a scanner module configured to detect a product identification and a survey response on a purchased item from two distinct identifiers or a single combination identifier, wherein the survey response is exposed through a consumer action on the purchased item; and
a processor module configured to:
provide the survey response to a survey system; and
provide the consumers an incentive.

13. The POS system of 12, wherein the processor module is further configured to provide the incentive in form of an automatic discount, a printed coupon, or a credit for future purchases.

14. The POS system of claim 12, wherein the processor module is further configured to provide the product identification to an inventory system.

15. (canceled)

16. The POS system of claim 12, wherein the survey response is configured to be exposed by peeling of a label or removing an ink cover over a supplemental identifier corresponding to the survey response.

17. The POS system of claim 16, wherein available survey response selections are provided on a plurality of labels or ink covers over a plurality of supplemental identifiers on the purchased item.

18. The POS system of claim 17, wherein the supplemental identifiers include a barcode or a QR code.

19. The POS system of claim 12, wherein the surveys response is configured to be exposed by peeling of a label or removing an ink cover over a portion of at combination identifier that includes the product identification.

20. The POS system of claim 19, wherein the combination identifier is configured to provide a combination of the product identification and the survey response in response to the peeling of the label or the removal of the ink cover.

21. The POS system of claim 19, wherein the combination identifier includes a barcode or a QR code.

22. The POS system of claim 12, wherein multiple survey responses are configured to be exposed by offering groups of survey selections such that one response per group is valid but the incentive accrues across different groups.

23. The POS system of claim 2, wherein the survey response is configured to be exposed by rendering a pre-programmed MID tag on the purchased item operational through the consumer action.

24. An item identification system with survey capability, the item identification system comprising:
a product identifier on an item; and
two or more survey response selections on the item, configured to expose corresponding survey response identifiers machine-readable at a point of sale (POS) system after removal by a consumer action.

25. The item identification system of claim 24, wherein the survey response selections are configured to be removed through one or more of peeling of a label, scratching of an ink cover, or rendering operational of a pre-programmed RFID tag.

26. The item identification system of claim 25, wherein the peeled label or the scratched ink cover expose a barcode or a QR code.

27. The item identification system of claim 24, wherein the product identifier and the survey response selections are attached to the item as one or more labels or painted on the item.

28. (canceled)

29. The item identification system of claim 24, wherein the survey response identifiers are exposed through modification of at least a portion of a combination identifier that includes the product identifier.

30. The item identification system of claim 29, wherein one or more of the product identifier, the survey response selections, and the combination identifier include is barcode or a QR code.

31. The item identification system of claim 24, further comprising an indication on the item alerting a consumer about availability of an incentive to the consumer for exposing a survey response identifier.

32. A computer-readable storage medium with instructions stored thereon to survey consumers at a point of sale (POS) location, the instructions causing the method of claim 1 to be executed on a computing device.

33.-42. (canceled)
